(19) United States
(12) Patent Application Publication
(10) Pub. No.: US 2011/0108686 A1
(43) Pub. Date: May 12, 2011

(54) Suction device with an electrostatic flexible sticking sheet

(76) Inventor: Chun-Chieh Lu, Taipei (TW)

(21) Appl. No.: 12/614,384

(22) Filed: Nov. 6, 2009

(51) Int. Cl. F16B 47/00

(52) U.S. Cl. 248/205.6

(57) ABSTRACT

A suction device includes an electrostatic flexible sheet having a predetermined thickness; an attaching member permanently secured to the sheet and comprising a base, a neck on the base, and an outward extending peripheral flange on a top of the neck; and a holding member comprising a T-shaped recess and a holding element extending outwardly. In response to sticking the sheet to a smooth surface by pressing the sheet a vacuum is created therebetween. The recess is adapted to slidably, securely attach to the attaching member.

### BACKGROUND OF THE INVENTION

1. Field of Invention

The invention relates to suction cups and more particularly to a suction device having an electrostatic flexible sticking sheet for reliably sticking to a smooth surface.

2. Description of Related Art

A conventional suction cup is shown in FIG. 1. The suction cup comprises a plastic disc 11 having a gradually raised central portion, and a hook 12 integrally formed on an outer surface of the disc 11. In use, a person may press the disc 11 to a smooth surface to greatly reduce air pressure inside, thereby creating a vacuum inside. Then the person may hang an article such as a hanger on the hook 12.

However, the well known suction cup suffers from several disadvantages. For example, the disc 11 may deform permanently due to increased times of use. Hence, air may flow into the disc 11 to decrease the degree of vacuum. This in turn can greatly decrease an atmospheric pressure difference between the disc outside and inside, i.e., decreased suction. Eventually, the suction cup may fall after putting even a light load on the hook 12.

There have been numerous suggestions in prior patents for suction cups. For example, U.S. Pat. No. 6,932,306 discloses a rapid-actuating suction cup device. Thus, continuing improvements in the exploitation of suction cup are constantly being sought.

### SUMMARY OF THE INVENTION

It is therefore one object of the invention to provide a suction device having an electrostatic flexible sticking sheet for reliably sticking to a smooth surface.

The above and other objects, features and advantages of the invention will become apparent from the following detailed description taken with the accompanying drawings.

### BRIEF DESCRIPTION OF THE DRAWINGS

FIG. 1 is a perspective view of a conventional suction cup;

FIG. 2 is an exploded view of a first preferred embodiment of suction device according to the invention;

FIG. 3 is a sectional view of the assembled suction device of FIG. 2 stuck to a smooth surface;

FIG. 4 is another sectional view of the assembled suction device of FIG. 2 stuck to the smooth surface;

FIG. 5 is a perspective view of a second preferred embodiment of suction device according to the invention;

FIG. 6 is a perspective view of the first preferred embodiment of suction device according to the invention;

FIG. 7 is a perspective view of the third preferred embodiment of suction device according to the invention; and

FIG. 8 is a perspective view of the fourth preferred embodiment of suction device according to the invention.

### DETAILED DESCRIPTION OF THE INVENTION

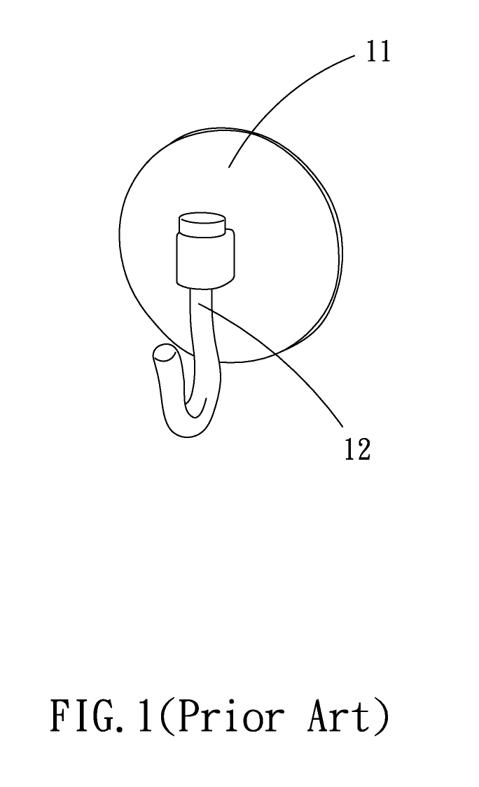

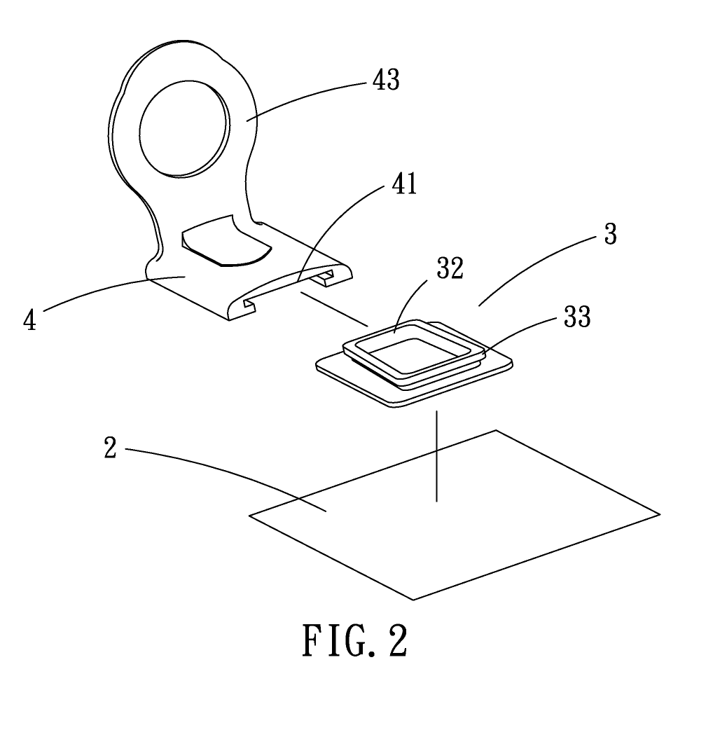

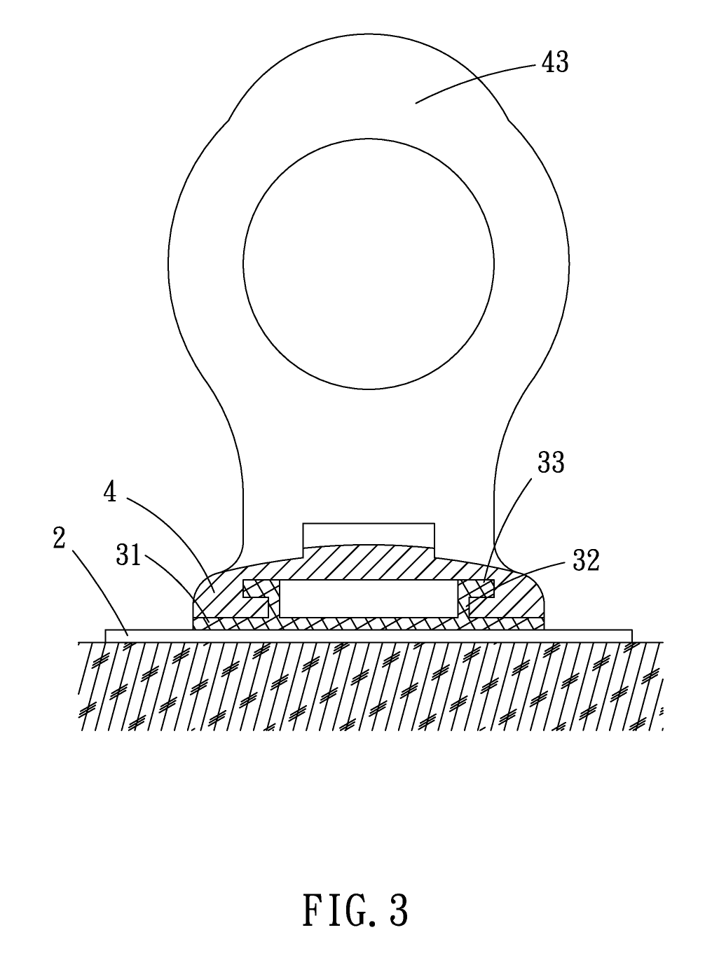

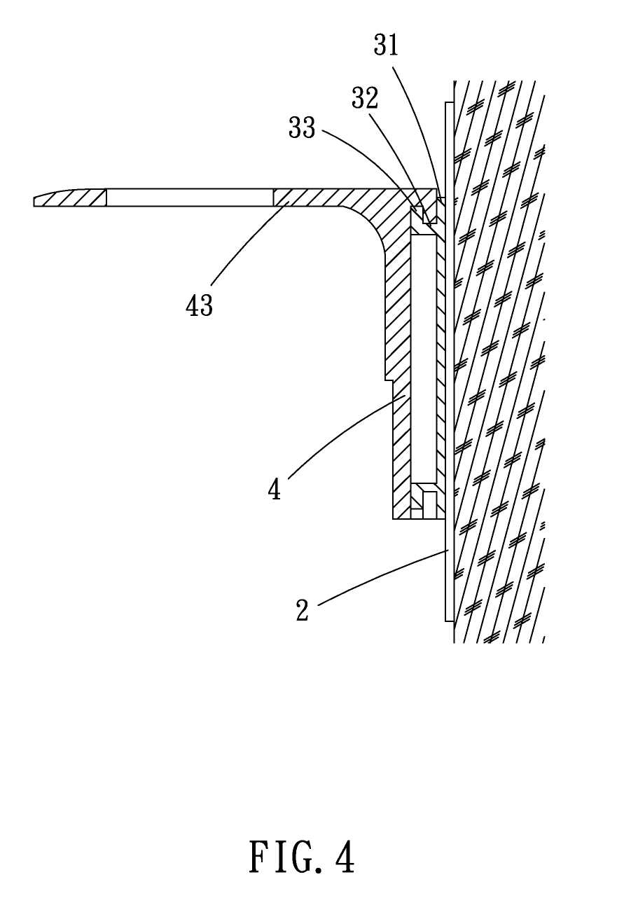

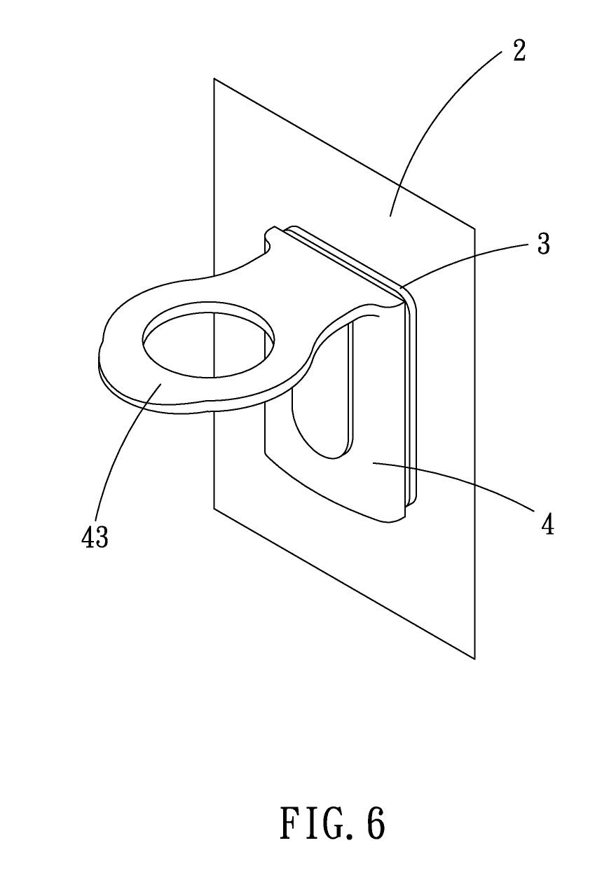

Referring to FIGS. 1 to 4 and 6, a suction device in accordance with a first preferred embodiment of the invention comprises the following components as discussed in detail below.

A flexible sheet 2 made of soft plastic such as PE (polyethylene) or PP (polypropylene) has a shape of rectangle. The sheet 2 has a thickness in a range of 0.05 mm to 0.5 mm. Moreover, the sheet 2 has an electrostatic nature.

An attaching member 3 comprises a rectangular base 31, a rectangular neck 32 formed on a central portion of the base 31, and an outward extending peripheral flange 33 formed on a top of the neck 32.

A holding member 4 comprises a T-shaped recess 41 on an inner surface facing the attaching member 3, and a tumbler holder 43 extending outwardly from an edge. The recess 41 is a mating member of the flange 33, the neck 32, and the base 31 together.

Both the attaching member 3 and the holding member 4 are formed of hard plastic. Also, the attaching member 3 is either formed integrally with the holding member 4 or manufactured separately prior to assembly together by means of adhesive. That is, both the attaching member 3 and the holding member 4 are sold as a unit.

In use, a person may stick the sheet 2 to a smooth surface (e.g., bathroom tile) by pressing the sheet 2. The electrostatic nature of the sheet 2 can substantially completely stick same to the surface with air therebetween being completely squeezed out, thereby creating a vacuum therebetween. Further, atmospheric pressure outside the attaching member 3 is much higher than the vacuum so that both the attaching member 3 and the sheet 2 are prevented from lifting off the surface. Then the person may align the recess 41 with all of the flange 33, the neck 32, and the base 31 and then slidably attach the recess 41 thereto until the sliding operation is stopped by bottoms of both side channels of the recess 41. As a result, the suction device is assembled. In this embodiment, a toothbrush may be hanged on the tumbler holder 43.

It is contemplated by the invention that the suction is sufficiently strong to prevent both the suction device and an article hanged thereon from falling. Moreover, both assembly and disassembly of the suction device are easy.

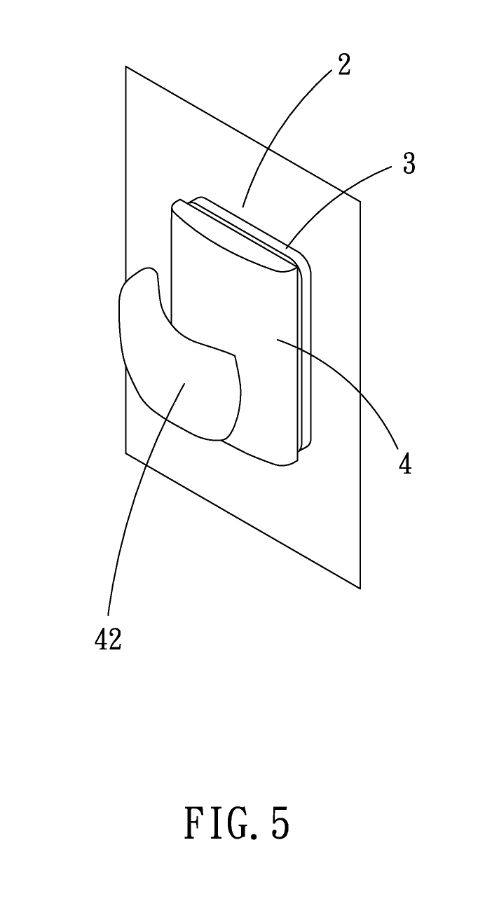

Referring to FIG. 5, a suction device in accordance with a second preferred embodiment of the invention is shown. The characteristic of the second preferred embodiment is detailed below. The tumbler holder 43 is replaced with a hook 42 for hanging an article (e.g., hanger) thereon.

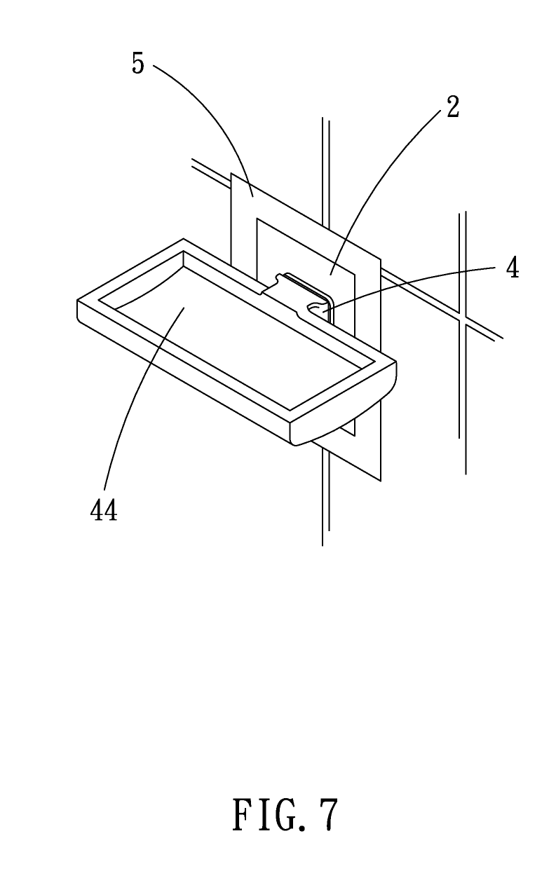

Referring to FIG. 7, a suction device in accordance with a third preferred embodiment of the invention is shown. The characteristics of the third preferred embodiment are detailed below. An auxiliary sheet 5 has both surfaces being smooth in which an inner surface of the sheet 5 is adapted to adhere to a non-smooth surface (e.g., bathroom tiles) and an outer surface of the sheet 5 is adapted to adhere to the sheet 2 due to the electrostatic nature of the sheet 2. Moreover, the hook 42 is replaced by a soap dish 44.

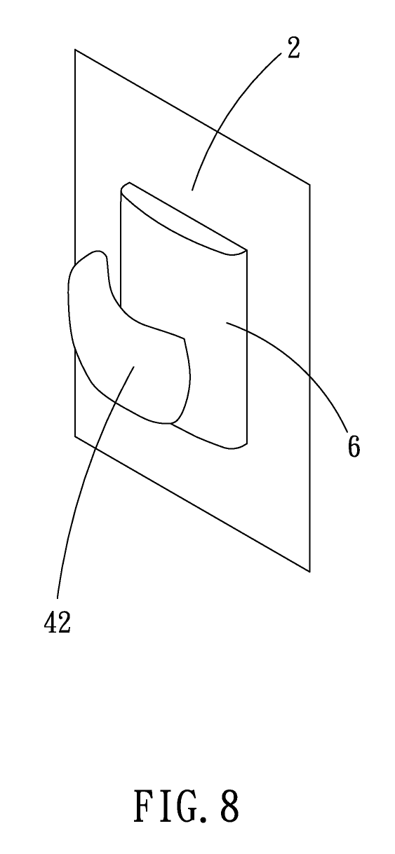

Referring to FIG. 8, a suction device in accordance with a fourth preferred embodiment of the invention is shown. The fourth preferred embodiment is a modification of the second preferred embodiment with a unitary base member 6 being formed integrally with the sheet 2 (or adhered together by means of adhesive) as a replacement of both the attaching member 3 and the holding member 4.

While the invention herein disclosed has been described by means of specific embodiments, numerous modifications and variations could be made thereto by those skilled in the art without departing from the scope and spirit of the invention set forth in the claims.

1. A suction device comprising:
an electrostatic flexible sheet formed of PE (polyethylene) or PP (polypropylene) and having a thickness in a range of 0.05 mm to 0.5 mm;
an attaching member permanently secured to the sheet and comprising a base, a neck on the base, and an outward extending peripheral flange on a top of the neck; and
a holding member comprising a T-shaped recess and a holding element extending outwardly;
wherein in response to sticking the sheet to a smooth surface by pressing the sheet a vacuum is created therebetween; and
wherein the recess is adapted to slidably, securely attach to the attaching member.

2-4. (canceled)
